(19) United States
(12) Patent Application Publication
(10) Pub. No.: US 2013/0066986 A1
(43) Pub. Date: Mar. 14, 2013

(54) AGGREGATING CHECK-IN SOCIAL NETWORKING SYSTEM AND METHOD

(71) Applicant: Joseph R. DiCosola, Chicago, IL (US)

(72) Inventor: Joseph R. DiCosola, Chicago, IL (US)

(73) Assignee: Get HookD LLC, St. Charles, IL (US)

(21) Appl. No.: 13/611,457

(22) Filed: Sep. 12, 2012

Related U.S. Application Data
(60) Provisional application No. 61/533,498, filed on Sep. 12, 2011.
(60) Provisional application No. 61/637,884, filed on Apr. 25, 2012.

(51) Int. Cl. G06F 15/16

(52) U.S. Cl. 709/206

(57) ABSTRACT

A method includes processing location data received from a mobile device with the communication interface, identifying a number of check-in locations located within a predetermined distance of the mobile device based on the location data, and generating a first message including the check-in locations located within the predetermined distance of the mobile device. The location data is associated with a user account. A second message received with the communication device from the mobile device is processed, and check-in data included in the second message is stored in a non-transient machine readable storage medium such that the check-in data is associated with the user account.

### CROSS-REFERENCE TO RELATED APPLICATIONS

This application claims priority to U.S. provisional patent application 61/533,498, filed Sep. 12, 2011, and to U.S. provisional patent application 61/637,884, filed Apr. 25, 2012, the entireties of which are herein incorporated by reference.

### FIELD

The disclosed systems and methods relate to web-based social networks. More particularly, the disclosed systems and methods relate to aggregating check-in data from a plurality of users and/or from a plurality of web-based social networks.

### BACKGROUND

Web-based social networks are online communities that enable people to share information about themselves and review information about their friends or things that interest them. While many different web-based social networks exist, each typically includes the ability for a user to create a public profile that any member of the social network can view or a private profile that only a select number of people can view such as people that have a direct relationship with the person as determined by the social network. The direct relationship typically requires an interaction between two people such as an invitation to be a friend or linked and an acceptance of the invitation.

### SUMMARY

In some embodiments, a system includes a non-transient machine readable storage medium, a communication interface configured to transmit and receive messages via a network, and a processor in signal communication with the non-transient machine readable storage medium and the communication interface. The processor is configured to process location data received from a mobile device with the communication interface, identify a number of check-in locations located within a predetermined distance of the mobile device based on the location data, and generate a first message including the check-in locations located within the predetermined distance of the mobile device. The location data is associated with a user account,

The processor is configured to cause the communication interface to transmit the first message to the mobile device, process a second message received with the communication device from the mobile device, and cause check-in data included in the second message to be stored in the non-transient machine readable storage medium such that the check-in data is associated with the user account.

In some embodiments, a method includes processing location data received from a mobile device with the communication interface, identifying a number of check-in locations located within a predetermined distance of the mobile device based on the location data, and generating a first message including the check-in locations located within the predetermined distance of the mobile device. The location data is associated with a user account. A second message received with the communication device from the mobile device is processed, and check-in data included in the second message is stored in a non-transient machine readable storage medium such that the check-in data is associated with the user account.

In some embodiments, a non-transient machine readable storage medium is encoded with program code, wherein when the program code is executed by a processor, the processor performs a method. The method includes processing location data received from a mobile device with the communication interface, identifying a number of check-in locations located within a predetermined distance of the mobile device based on the location data, and generating a first message including the check-in locations located within the predetermined distance of the mobile device. The location data is associated with a user account. A second message received with the communication device from the mobile device is processed, and check-in data included in the second message is stored in a non-transient machine readable storage medium such that the check-in data is associated with the user account.

### BRIEF DESCRIPTION OF THE DRAWINGS

FIG. 1 illustrates one example of a network of mobile and wired devices including a plurality of social networks and an aggregating social network.

FIG. 2 illustrates one example of the components of a mobile device illustrated in FIG. 1.

FIG. 3 illustrates one example of a plurality of users of a plurality of web-based social networks and a plurality of users of an aggregating social network.

FIG. 4A illustrates one example of the flow of data between a mobile device, a social network, and an aggregating social network.

FIG. 4B illustrates one example of the flow of data between mobile devices running an application for an aggregating check-in social network, the aggregating check-in social network, and a commercial user accessing the check-in data.

FIG. 5 illustrates one example of a mobile device displaying the identities of other users that have checked into a location to a user using the aggregating social network.

FIG. 6 is a flow diagram of one example of a method performed by aggregating social network in accordance with some embodiments.

FIG. 7 illustrates one example of a first user of an aggregating social network transmitting a message to a second user of the aggregating social network.

FIG. 8 illustrates one example of a message board for a location to which checked in users at the location can post messages.

FIG. 9 illustrates one example of a commercial user transmitting a message to a plurality of users that are currently checked in a check-in location.

FIG. 10 illustrates one example of an commercial user sending a communication to users that are currently checked or have previously checked into a location.

### DETAILED DESCRIPTION

System and methods that enable the aggregation of location based “check-ins” are described below. In exemplary embodiments, the method and system are web-based and enable users and business owners to communicate with other registered users of the social network. In some embodiments, the social network aggregates user check-in data from a plurality of different location-based social networking applications.

The Internet is a worldwide system of computer networks—a network of networks in which a user at one computer or other device connected to the network can obtain information from any other computer and communicate with users of other computers or devices. The most widely used part of the Internet is the World Wide Web (often-abbreviated “WWW” or called “the Web”).

One of the most outstanding features of the Web is its use of hypertext, which is a method of cross-referencing. In most Web sites, certain words or phrases appear in text of a different color than the surrounding text. This text is often also underlined. Sometimes, there are hot spots, such as buttons, images, or portions of images that are “clickable.” Clicking on hypertext or a hot spot causes the downloading of another web page via a protocol such as hypertext transport protocol (HTTP). Using the Web provides access to millions of pages of information. Web “surfing” is done with a Web browser such as, for example, Apple Safari, Microsoft Internet Explorer, Mozilla Firefox, and Google Chrome. The appearance of a particular website may vary slightly depending on the particular browser used. Versions of browsers have “plug-ins,” which provide animation, virtual reality, sound, and music. Interpreted programs (e.g., applets) may be run within the browser.

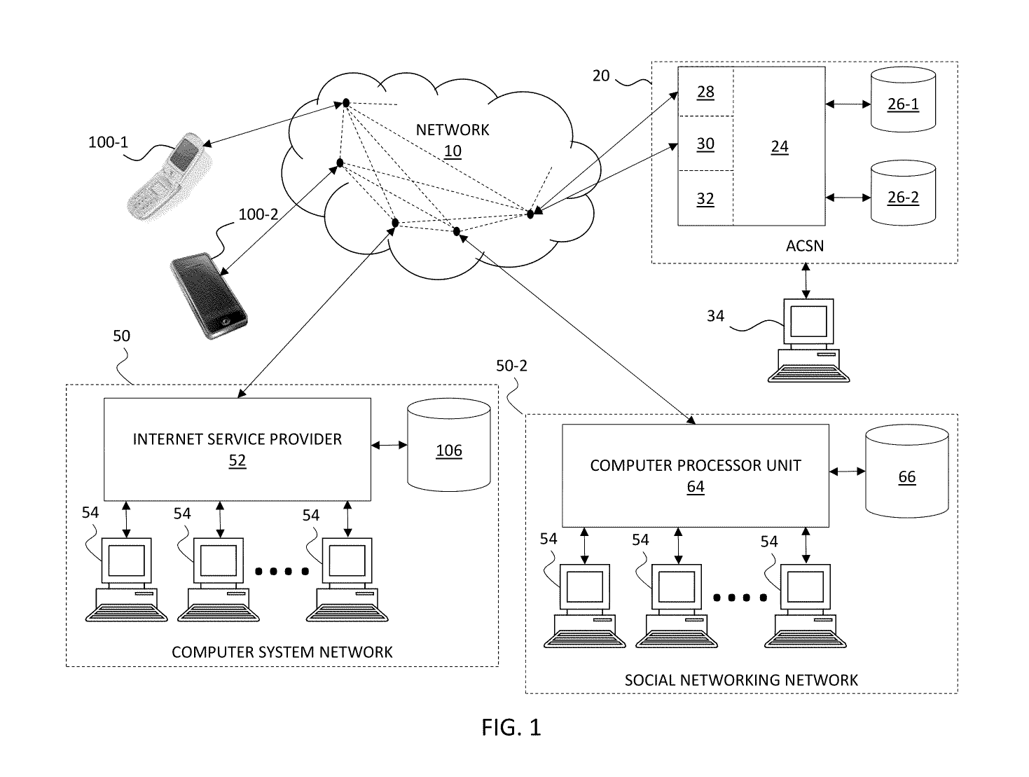

FIG. 1 shows a system in which a plurality of wireless devices 100-1 and 100-2 (collectively “wireless devices 100” or “mobile devices 100”) are connected via network 10 to one or more computer system networks 50, one or more social networks 60, and to Aggregating and Check-in Social Network (“ACSN”) 20. Network 10 may be a wide area network (“WAN”), a local area network (“LAN”), personal area network (“PAN”), or the like. In one embodiment, network 10 is the Internet and mobile devices 100 are online “Online” may mean connecting to or accessing source data or information from a location remote from other devices or networks coupled to Internet 10.

ACSN 20 includes a processing unit 24 coupled to one or more data storage units 26-1, 26-2 (collectively referred to as “data storage units 26”). The processing unit 24 provides front-end graphical user interfaces (“GUIs”), e.g., subscriber GUI or interface 28, commercial user GUI or portal 30, and back-end or administrative GUI or portal 32 to a remote computer 54 or to local computer 34. The GUIs can take the form of, for example, a webpage that is displayed using a browser program local to remote computers 54 or to one or more local computers 34. It is understood that the ACSN 20 may be implemented on one or more computers, servers, or like devices. For example, ACSN 20 may include servers programmed or partitioned based on permitted access to data stored in data storage units 26. Front-and back-end GUIs 28, 30, 32 may be portal pages that include various content retrieved from the one or more data storage devices 26. As used herein, “portal” is not limited to general-purpose Internet portals, such as YAHOO! or GOOGLE but also includes GUIs that are of interest to specific, limited audiences and that provide the party access to a plurality of different kinds of related or unrelated information, links and tools as described below. “Webpage” and “website” may be used interchangeably herein.

Remote computers 54 may be part of a computer system network 50 and gain access to network 10 through an Internet service provider (“ISP”) 52. Mobile devices 100 may gain access to network 10 through a wireless cellular communication network, a WAN hotspot, or through a wired or wireless connection with a computer as will be understood by one skilled in the art. Subscribers or commercial users may use remote computers 54 to gain access to ACSN 20 and/or to social network 60.

Social Network 60 may include a server or hub 64 to which a plurality of users gain access using terminals 54, such as a computer. Terminals 54 may be directly connected to network 10 or be connected through a gateway 64, which may be a processing device coupled to one or more data storage units 66.

In one embodiment, mobile devices 100 includes any mobile device capable of transmitting and receiving wireless signals. Examples of mobile instruments include, but are not limited to, mobile or cellular phones, personal digital assistants (“PDAs”), laptop computers, tablet computers, music players, and e-readers, to name a few possible devices.

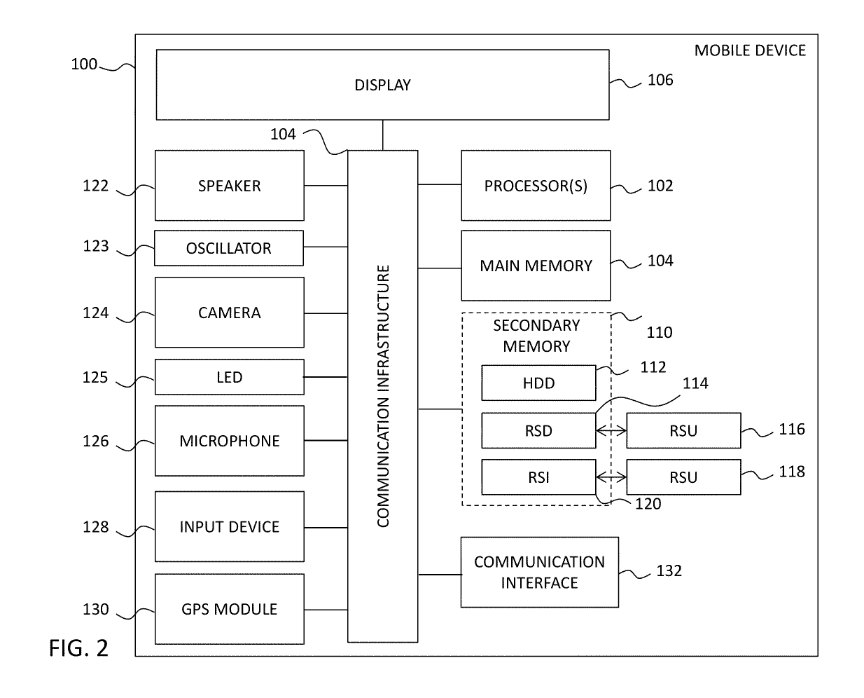

FIG. 2 is a block diagram of one example of an architecture of mobile device 100. As shown in FIG. 2, mobile device 100 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary mobile device 100. After reading this description, it will be apparent to one skilled in the art how to implement the method using mobile devices 100 that include other systems or architectures. One of ordinary skill in the art will understand that computers 34, 54 may have a similar architecture as that of mobile devices 100.

Mobile device 100 includes a display 106 that displays graphics, video, text, and other data received from the communication infrastructure 104 (or from a frame buffer not shown) to a user (e.g., a subscriber, commercial user, back-end user, or other user). Examples of such displays 106 include, but are not limited to, LCD screens, OLED display, capacitive touch screen, and a plasma display, to name a few possible displays. Mobile instrument 100 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SDD”), or the like. In some embodiments, removable storage drive 114 reads from and/or writes to a removable storage unit (“RSU”) 116 in a manner that is understood by one skilled in the art. Removable storage unit 116 represents a magnetic tape, optical disk, or the like, which may be read by and written to by removable storage drive 114. As will be understood by one skilled in the art, the removable storage unit 116 may include a tangible and non-transient machine readable storage medium having stored therein computer software and/or data.

In some embodiments, secondary memory 110 may include other devices for allowing computer programs or other instructions to be loaded into mobile device 100. Such devices may include, for example, a removable storage unit (“RSU”) 118 and a corresponding interface (“RSI”) 120. Examples of such units 118 interfaces 120 may include a removable memory chip (such as an erasable programmable read only memory (“EPROM”)) programmable read only memory (“PROM”)), secure digital (“SD”) card and associated socket, and other removable storage units 118 and interfaces 120, which allow software and data to be transferred from the removable storage unit 118 to mobile device 100.

Mobile device 100 may also include a speaker 122, an oscillator 123, a camera 124, a light emitting diode (“LED”) 125, a microphone 126, an input device 128, and a global positioning system (“GPS”) module 130. Examples of input device 128 include, but are not limited to, a keyboard, buttons, a trackball, or any other interface or device through a user may input data. In some embodiment, input device 128 and display 106 are integrated into the same device. For example, display 106 and input device 128 may be touchscreen through which a user uses a finger, pen, or stylus to input data into mobile instrument 100.

Mobile device 100 also include one or more communication interfaces 130, which allows software and data to be transferred between mobile device 100 and external devices such as, for example, another mobile device 100, a point-of-sale (“POS”) device, an automated teller machine (“ATM”), a computer, and other devices that may be locally or remotely connected to mobile device 100. Examples of the one or more communication interfaces 130 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 130 may also include a wireless interface configured for short range communication, such as near field communication (“NFC”), Bluetooth, or other interface for communication via another wireless communication protocol. One skilled in the art will understand that computers 34, 54 and portions of social network 60 and ACSN 20 may include some or all components of mobile device 100.

Software and data transferred via the one or more communications interfaces 132 are in the form of signals, which may be electronic, electromagnetic, optical, or other signals capable of being received by communications interfaces 132. These signals are provided to communications interface 132 via a communications path or channel. The channel may be implemented using wire or cable, fiber optics, a telephone line, a cellular link, a radio frequency (“RF”) link, or other communication channels.

In this document, the terms “non-transient computer program medium” and “non-transient computer readable medium” refer to media such as removable storage units 116, 118, or a hard disk installed in hard disk drive 112. These computer program products provide software to mobile device 100. Computer programs (also referred to as “computer control logic”) may be stored in main memory 108 and/or secondary memory 110. Computer programs may also be received via the one or more communications interfaces 132. Such computer programs, when executed by a processor(s) 102, enable the mobile device 100 to perform the features of the method discussed herein.

In an embodiment where the method is implemented using software, the software may be stored in a computer program product and loaded into mobile device 100 using removable storage drive 114, hard drive 112, and/or communications interface 132. The software, when executed by a processor(s) 102, causes the processor(s) 102 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

ACSN 20, which communicate with users running an application on a mobile device 100 or with users via web browser on a computer 54, provides a service that aggregates location-based “check-ins” across different location-based social networking applications and services, e.g., Foursquare, Google Latitude, Google+, LinkedIn, Facebook, to name only a few exemplary social network applications. As will be understood by one of ordinary skill in the art, a “check-in” in the context of a social networking application enables a subscriber to register with the social networking application that they are presently located at a particular location such as a store, restaurant, bar, amusement park, or other point-of-interest hereinafter referred to as a “Check-In Location.”

ACSN 20 also enables non-commercial users to “check-in” at a Check-In Location and to communicate with other non-commercial users of ACSN 20 that are also logged into ACSN 20 and/or are checked-in at a particular location. In some embodiments described in greater detail below, non-commercial users can transmit or receive messages to any other non-commercial user whether or not the other non-commercial user is actively logged into the system (e.g., via mobile device 100 or computer 54) or is directly connected with the other non-commercial user. Additionally, ACSN 20 provides business owners or proprietors (i.e., “commercial users”) with communication access to currently logged-in non-commercial users as well as checked-in users or previously checked-in non-commercial users, via commercial user portal 30. In some embodiments, marketers and promoters are provided with the ability to transmit marketing, offers, or promotional information to non-commercial users by contacting or working with an administrator of ACSN 20 that transmits the message on behalf of the marketer or promoter using the administrative GUI or portal 32.

In some embodiments, a check-in is accomplished with ACSN 20 by a non-commercial user selecting the Check-In Location from a plurality of locations displayed to the user on 106 a mobile device 100. The locations that are displayed are selected based on the location's proximity to the non-commercial user's location as determined by the GPS module 130 of mobile device 100 being used by the non-commercial user. For example, GPS module 130 provides the non-commercial user's location to ACSN 20, which consults a database stored in a data storage unit 26 and determines the closest number of possible Check-In Locations. In some embodiments, ACSN 20 communicates with a third-party database, e.g., a Google or Yahoo! database, via network 10 to determine the closest Check-In Locations. In some embodiments, a non-commercial checks in at a Check-In Location by using a wireless access point (e.g., WiFi router) installed at the Check-In Location. The identity of the wireless access point is used by ACSN 20 to identify the location at which the non-commercial user is checking in.

A non-commercial user is presented with a GUI displaying a number of potential Check-In Locations on display 106 of mobile device 100. The non-commercial user makes the selection of the Check-In Location using input device 128, and mobile device 100 (or computer 54) transmits data to ACSN 20 identifying that the non-commercial user has checked in at the Check-In Location. In some embodiments, the message transmitted to ACSN 20 also includes the device identification (“ID”) number of the device by which the non-commercial user accesses ACSN 20. Examples of the device ID include, but are not limited to, a mobile identification number (“MIN”), a mobile subscription identification number (“MSIN”), a media access control (“MAC”) address, or other device ID number as will be understood by one of ordinary skill in the art. Other information that can be transmitted in the message to ACSN 20 includes, but is not limited to, a user profile picture, a user profile name, a user email address, and a user mobile telephone number to list but only a few examples of information. In some embodiments, the user profile picture, user profile name, user email address, and other non-commercial user data is stored by ACSN 20 during a registration process and the message includes only a subset of the data (e.g., the device ID) such that ACSN 20 can identify the account of the non-commercial user that transmitted the message.

If a non-commercial user is checking in at a Check-In Location using another social network 60, then GPS module 130 provides the non-commercial user's location information to a social network application running on mobile device 100 that communicates with social network 60 via network 10. In some embodiments, the Check-In Location has a profile or account with the social network 60, which enables the Check-In Location to be displayed to the non-commercial user and for the non-commercial user to be checked-in at the Check-In Location.

The selection is made by the non-commercial user using input device 128 of mobile device 100. In response to the selection, social network application running on mobile device 100 causes mobile device 100 to transmit data to social network 60, which stores the non-commercial user's check-in information in data storage unit 66. The check-in data stored by the multiple social networks 60 are valuable to merchants and advertisers, but are not available in a single interface as these merchants and advertisers need to separately access each social network 60.

As mentioned above, ACSN 20 advantageously provides such data aggregation and enables merchants and business proprietors (i.e., commercial users) to disseminate marketing and promotional materials to non-commercial users. Additionally, ACSN 20 enables commercial and non-commercial users to receive a feed of offers, promotions/deals/messages of other commercial users offers/promotions/deals/messages that are presently available for all commercial and non-commercial users to view in real time via a Shout Board. These offers/promotions/deals/messages will be transmitted through portal 30 and received by non-commercial users on a mobile device 100 (via an application) or on a computer (via an application or via a web browser) in real time.

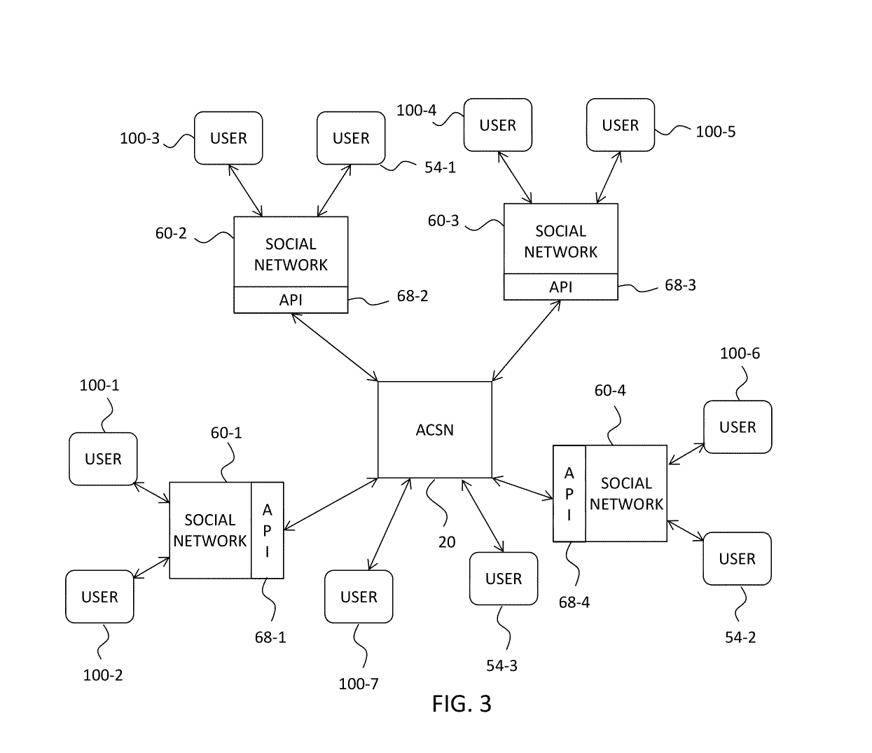

For example and referring to FIG. 3, ACSN 20 interfaces with social networks 60-1, 60-2, 60-2, 60-3, and 60-4 (collectively “social networks 60”) via each network's respective application programming interface (“API”) 68-1, 68-2, 68-3, and 68-4 (collectively “APIs 68”) and network 10. Through network 10 and APIs 68 of social networks 60, ACSN 20 aggregates non-commercial user data including non-commercial user check-in data where it is stored in one or more storage devices 26.

As will be understood by one of ordinary skill in the art, non-commercial users typically check-in at a Check-In Location using a mobile device 100, but it is also possible for a non-commercial user to check-in at a Check-In Location using a computer 54. Non-commercial users of social network 60-1 communicate with social network 60-1 using, for example, mobile devices 100-1 and 100-2; non-commercial users of social network 60-2 communicate with social network 60-2 using mobile device 100-3 and computer 54-1; and non-commercial users of social network 60-3 communicate with social network 60-3 using mobile devices 100-4 and 100-5. Social network 60-4 communicates with a non-commercial user using a mobile device 100-6 and with a non-commercial user using a computer 54-2.

In addition to aggregating check-in and non-commercial user data, ACSN 20 provides the aggregated data to users (i.e., commercial and non-commercial users) registered with ACSN 20. For example and as illustrated in FIG. 3, one non-commercial user communicates with ACSN 20 using a mobile device 100-7, and a commercial user communicates with ACSN 20 using a computer 54-3. In some embodiments, communication between mobile device 100-7 and ACSN 20 is facilitated by an application running on mobile device 100-7 that is executed by processor(s) 102 of mobile device 100-7. As will be understood by one of ordinary skill in the art, mobile devices 100 and computers 54 can access multiple social networks simultaneously. Put another away, a user can be simultaneously logged into social network 60-1 and 60-2 and into ACSN 20 using a mobile device 100 and/or computer 54.

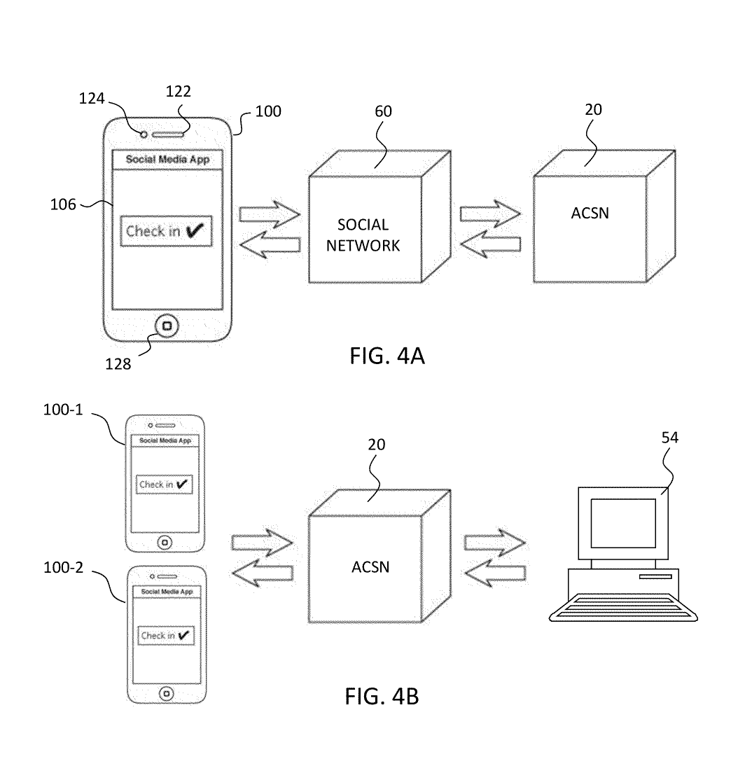

In some embodiments, commercial users can use ACSN 20 to aggregate their check-ins across multiple platforms/social networks 60 into a single repository that enables the commercial users to provide targeted marketing to non-commercial users that have been or are presented checked-in at the Check-In Location of the commercial user. For example, when a non-commercial user checks-in at a Check-In Location using either the application of the ACSN 20 running on a mobile device 100 and/or other social media applications 60, signals, including non-commercial user data, are transferred from mobile device 100 or computer 54 to the social media network 60, which then forwards data about the non-commercial user to ACSN 20 as illustrated in FIG. 4A.

Social network 60 provides the non-commercial user data, including the check-in information, received from mobile device 100 or computer 54 to ACSN 20 where it is stored. In some embodiments, the check-in information of a Check-In Location is provided ACSN 20 if the Check-In Location has registered with social network 60. For example, if a commercial user has created/registered a profile on a first social network, e.g., social network 60-1, which includes a username and password, and has also registered with ACSN 20, then social network 60 will forward the check-in data to ACSN 20 where it is associated with the account of the Check-In Location and is available to a commercial user via commercial user portal 30. In some embodiments, the authentication between ACSN 20 and other social media application subscribers (commercial and non-commercial users) may be performed using a federated identity model.

In some embodiments, a commercial user is provided access to the check-in data for the Check-In Location after registering with an administrator of ACSN 20. The administrator may vet the identity of the person trying to establish a commercial user account to prove that the person is in fact an owner or authorized representative of the Check-In Location. The vetting process may include providing the administrator with tax records, personal identification that matches state or federal government records that identify the person as being an owner or representative of the Check-In Location, or other information to confirm that the person is authorized to act on behalf of the Check-In Location.

ACSN 20 enables commercial users to access check-in or previously checked-in data for non-commercial users of ACSN 20 that checked into a Check-In Location of the commercial user via the commercial user portal 30. For example, ACSN 20 aggregates the data for each non-commercial user that checks in at a Check-In Location, even if the Check-In Location is not registered with ACSN 20. As described above, ACSN 20 enables the aggregation of data for a Check-In Location based on a local database or third-party database (e.g., a Google or Yahoo! database) of Check-In Locations such that ACSN 20 aggregates data for businesses and other Check-In Locations even if the business has not registered with an administrator of ACSN 20.

In some embodiments, ACSN 20 charges a fee (e.g., a one-time use fee, a weekly fee, a monthly fee, annual fee, etc.) to commercial users for the commercial users to gain access to the check-in data that ACSN 20 has aggregated concerning the Check-In Location of the commercial user. For example and as illustrated in FIG. 4B, ACSN 20 aggregates the check-in data received from mobile devices 100-1, 100-2 and provides the aggregated data to a commercial user accessing ACSN 20 via computer 54 and commercial user portal 30.

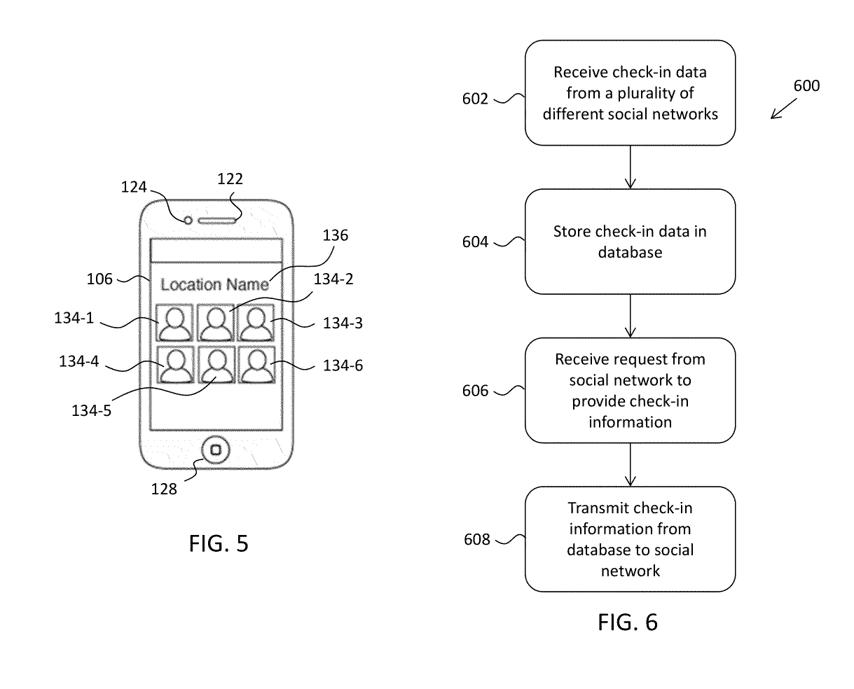

Commercial user portal 30 enables a commercial-user to review the users profile information of people that are presently checked into or have previously checked into a Check-In Location. For example and as illustrated in FIG. 5, display 106 of mobile device 100 displays the user profiles 134-1, 134-2, 134-3, 134-4, 134-5, 134-6 (collectively “user profiles 134”) along with the name 136 of the Check-In Location. One of ordinary skill in the art will understand that user profiles 10 can also be displayed on a display of a computer 54 if a commercial user accesses ACSN 20 via a web browser as shown in FIG. 4B.

In some embodiments, ACSN 20 restricts the amount of data of a non-commercial user that can be viewed by a commercial user. For example, ACSN 20 can restrict the view of the commercial user such that only the device IDs of the presently checked-in non-commercial users are visible to the commercial user. Other embodiments enable commercial users to view only a public profile of the non-commercial users, and yet other embodiments enable a commercial user to view the full profile of the non-commercial users that are presently checked in at a Check-In Location associated with the account of the commercial user.

In addition to commercial users being able to review the profiles of users that are presently and/or previously have been checked into a Check-In Location, non-commercial users are provided with the ability to communicate with any other non-commercial user that is presently or has logged into ACSN 20. For example, each non-commercial user can review the profiles of people that are presently or has used ACSN 20. In some embodiments, non-commercial users can search based on any non-commercial user profile data stored in the one or more databases of ACSN 20. ACSN 20 also enables a non-commercial user to view the profiles of the non-commercial users that are presently checked in at a Check-In Location even of the non-commercial user is not presently checked in at the same Check-In Location.

In response to a user input, e.g., in response to a non-commercial user entering search terms or a non-commercial user requesting to see currently active non-commercial users, ACSN 20 displays the profiles of contemporaneously active non-commercial users on a display 106 of a mobile device 106 regardless of whether or not the non-commercial users have a direct connection relationship with each other. As described above, a direct relationship between two people means that the two people have agreed to be directly related to one another, e.g., an offer to be directly related and an acceptance to the offer to be directly related. If two non-commercial users are not directly related (e.g., an offer and/or an acceptance of the offer has not be recorded by ACSN 20), then they can still send messages to one another (i.e., messages that are not solely an invitation or acceptance of the invitation).

In some embodiments, ACSN 20 enables other social networks 60 and their related applications to be used to display the profiles of checked-in non-commercial users if the non-commercial user's profile with the social network 60 is linked to an ACSN 20 profile. For example, FIG. 6 illustrates one example of a method 600 of storing and providing check-in information to a social network. As shown in FIG. 6, check-in data are received as ACSN 20 from a plurality of different social networks 60 at block 602. In some embodiments, the check-in data are provided to ACSN 20 in real-time as a non-commercial user of a social network checks into a particular location. In some embodiments, check-in data is received periodically at ACSN 20 in batches from social networks 60.

At block 604, the check-in data received from social networks 60 are stored in a database located in one or more data storage units 26 of ACSN 20. As will be understood by one of ordinary skill in the art, the check-in data are stored with registered non-commercial user data, if applicable, in the database of ACSN 20. For example, the check-in data for a particular Check-In Location received from each of the social networks 60 are stored in the database such that the data are associated with profile of the particular Check-In Location. Similarly, non-commercial user profiles maintained in the database of ACSN 20 are also updated to reflect that a non-commercial user checked in at a particular Check-In Location at a particular time.

At block 606, ACSN 20 receives a request from a social network 60 for check-in data. In some embodiments, the request from social network 60 includes a request for current check-in data for a particular Check-In Location. The request generated from social network 60 can be generated in response to a non-commercial user of the social network 60 requesting to see other people that are currently checked in at the Check-In Location. As will be understood by one of ordinary skill in the art, current check-in data may identify the people that have checked in at a Check-In Location within a predetermined period of time (e.g., within the last 10 minutes, 15 minutes, 30 minutes, etc.). In some embodiments, the request from social network 60 (and/or from the non-commercial user of social network 60) is not limited to a current identification of people that are checked-in such that ACSN 20 provides data for the Check-In Location that includes both current check-ins and historical check-ins.

At block 608, ACSN 20 transmits the requested data to social network 60. As described above, the data transmitted to social network 60 can include only real-time check-in data, only historical check-in data, or both real-time (e.g., check-ins that are within a predetermined window considered to be recent) and historical check-in data.

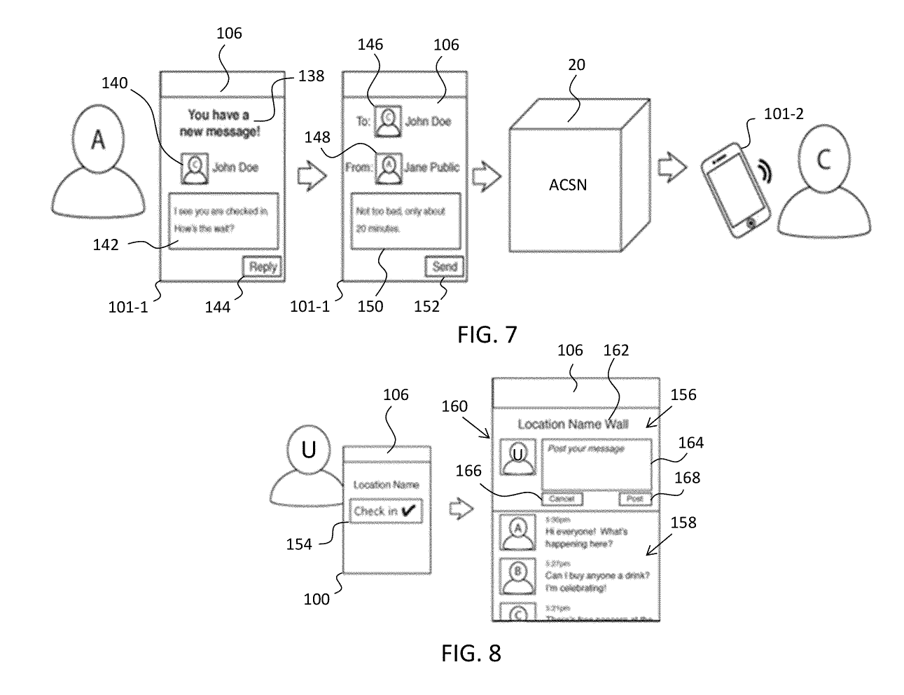

ACSN 20, which as described above can be used via a web-browser or in connection with an application running on a mobile device 100, also advantageously enables communication between non-commercial users that are contemporaneously using ACSN 20 (regardless of whether the non-commercial user accounts are directly related within ACSN 20) or are contemporaneously checked in at a Check-In Location. For example and as illustrated in FIG. 7, non-commercial user A receives a message on mobile device 100-1. A notification 138 is displayed to non-commercial user A on display 106 of mobile device 100-1. Additionally, non-commercial user A is provided with an identification 140 of the non-commercial user from which the message is received, i.e., non-commercial user C, and the text of the message in text box 142. Display 106 also displays a virtual button 144 enabling the non-commercial user to send a reply message.

If the non-commercial user that receives the message, i.e., non-commercial user A, wants to send a reply, then virtual button 144 is clicked or pressed using input device 128 causing a new screen to be displayed on display 106. The GUI for the reply screen identifies to whom the message is being addressed at area 146, from whom the message is being transmitted at area 148, and includes a text entry box 150 in which the text of the message is entered. A virtual “Send” button 152 is also provided such that when the user presses the virtual button using input device 128 the message is transmitted.

In response to virtual button 152 being pressed, the reply message is transmitted through network 10 to ACSN 20. As will be understood by one of ordinary skill in the art, the reply message can be transmitted from mobile device 100-1 to ACSN 20 using TCP/IP or other suitable transmission protocol. ACSN 20 routes the reply message to mobile device 100-2 of user C where the message is displayed on display 106. In some embodiments, the receipt of a message generates an audible signal or noise using speaker 122, generates a tactile signal using an oscillator 123, which causes the mobile device to vibrate, and/or generates a visual signal using display 122 or a LED 125 as will be understood by one of ordinary skill in the art.

In some embodiments, ACSN 20 enables non-commercial users that are checked in at the same Check-In Location to communicate with one another even if they are not directly connected via the same social network 60 or via ACSN 20. For example, ACSN 20 enables a non-commercial user to email, SMS text, instant message, or otherwise communicate with another non-commercial user that is checked into the same location by providing contact information to each non-commercial user. Depending on a non-commercial user's privacy settings, a non-commercial user may be able to access or view another non-commercial user's email address, phone number, or other contact information. The privacy settings also enable a non-commercial user to be contacted via email, SMS text, etc. without displaying the email address or phone number to other non-commercial users. Non-commercial users are also provided with the ability to block users (commercial and non-commercial) with whom they do not want to communicate and with the ability the receive messages only via ACSN 20 if they so desire.

In some embodiments, ACSN 20 also provides certain non-commercial users with the ability to restrict them from being identified in a search. In some embodiments, a non-commercial user can restrict others from identifying or contacting the user based on one or more domain levels of the user's email address. For example, a non-commercial user is provided with the ability to permit only those with the same top-level domain to contact him or her, e.g., only those users having email addresses with “.edu” can contact the non-commercial user. Alternatively or additionally, a non-commercial user can restrict the users that can contact the user to those non-commercial users with a common domain, e.g., only those non-commercial users with an email address ending with “@school.edu” can contact the non-commercial user. One of ordinary skill in the art will understand that ACSN 20 provides non-commercial users with the ability to restrict others from contacting them based on other criteria.

ACSN 20 and its associated application for running on mobile devices 100 also enables commonly checked-in non-commercial users to post comments to a message board for the Check-In Location. For example and as illustrated in FIG. 8, a non-commercial user U checks in at a Check-In Location using his/her mobile device 100. A graphic 154 illustrating the check-in status of the non-commercial user is displayed on display 106 of mobile device 100.

As illustrated on the right side of FIG. 8, a message board 156 is displayed by display 106 and includes an area 158 showing the previous posts to message board 156. A second area 160 includes a field 162 displaying the name of the Check-In Location, a text entry box 164 in which a message can be typed, a virtual “Cancel” button 166, and a virtual “Post” button 168.

ACSN 20 also provides commercial users with the ability to send messages via commercial user portal 30 to a Shout Board that is accessible by any non-commercial user. As will be understood by one of ordinary skill in the art, each commercial user enters a message, which is then displayed on the Shout Board. In some embodiments, a commercial user posts a message to the Shout Board by contacting the administrator for the ability to post a message on the Shout Board. For example, commercial user portal 30 receives a request to post a message on the Shout Board. An administrator via administrator portal 32 reviews the content of the message (e.g., to ensure appropriateness and that the account of the commercial user has not been hacked) and confirms or denies the posting of the message to the Shout Board. In some embodiments, the ability to post to the Shout Board requires the payment of a fee by commercial user to the administrator of ACSN 20. In some embodiments, any message transmitted by a commercial user or on behalf of a commercial user by an administrator is posted to the Shout Board automatically.

A non-commercial user can access the Shout Board via the mobile application or via a web browser. In some embodiments, a non-commercial user has the ability to search for messages from particular Check-In Locations, for messages from Check-In Locations in a particular geographic area (e.g., near the user based on the non-commercial user's GPS coordinators or based on a geographic query), or based on other criteria. In some embodiments, the non-commercial users are not provided with the ability to search for particular deals, and ACSN 20 determines the criteria that is displayed to the non-commercial users.

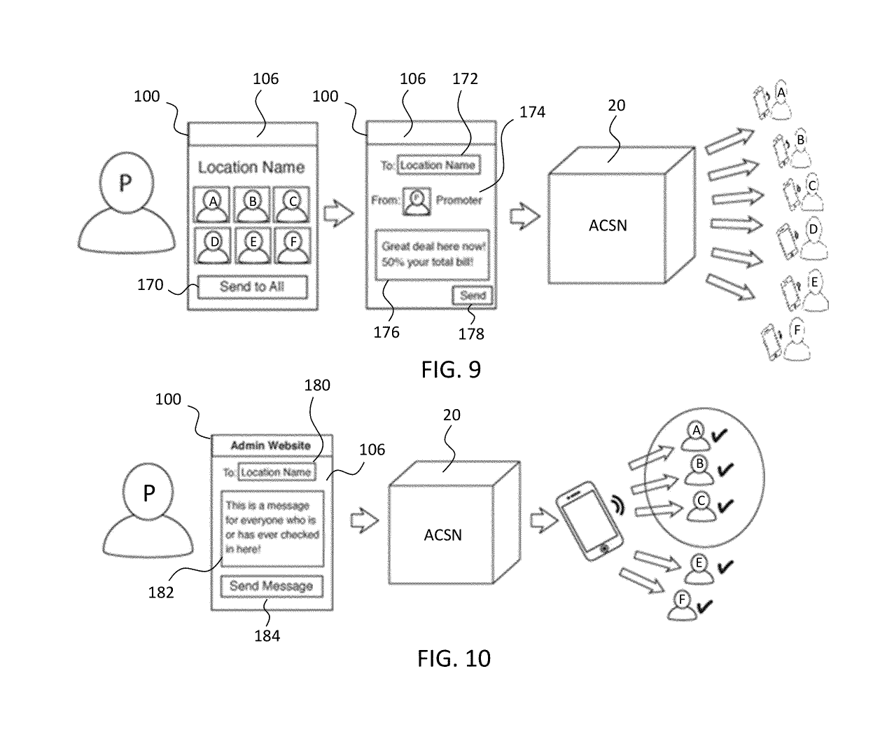

As briefly mentioned above, ACSN 20 and its associated application for mobile devices advantageously enables commercial users to view people who have checked in at Check-In or have ever checked in at a Check-In Location as illustrated in FIG. 9 through commercial user portal 30 provided by ACSN 20. As shown in FIG. 9, a commercial user, P, can view the identity of the non-commercial users (e.g., non-commercial users A, B, C, D, E, F) that have checked in or have ever checked in at a Check-In Location via a mobile device 100 or a remote terminal 54 via network 10 as will be understood by one skilled in the art. Examples of the types of messages that a commercial user may transmit include, but are not limited to, promotions, offers, deals, discounts, coupons, or the like.

The GUI presented by display 106 to commercial user P includes a virtual button 170, which enables commercial user P to transmit a message to each non-commercial user that is checked in or has previously checked in at the Check-In Location when pressed. Pressing virtual button 170 brings up another GUI that includes an area 172 identifying that the message will be transmitted to each non-commercial user that is currently checked in or has previously checked in at the Check-In Location, an area 174 identifying the profile of the person transmitting the message, i.e., commercial user P, and a text entry box 176 in which the message is entered. A “Send” virtual button is also provided.

Pressing the Send virtual button causes the message entered in text entry box 176 to be transmitted to ACSN 20 via network 10. In some embodiments, the message from mobile device 100 (or remote computer 54) is transmitted to ACSN 20 using TCP/IP or other suitable communication protocol. ACSN 20 receives the message from mobile device 100 (or remote terminal 54) and transmits the message to each non-commercial user, i.e., non-commercial users A, B, C, D, E, F, that is currently checked in at the Check-In Location. The message from ACSN 20 to non-commercial users A, B, C, D, E, F can be transmitted using TCP/IP, via an email protocol, SMS protocol, or other suitable communication protocol as will be understood by one of ordinary skill in the art. In some embodiments, the receipt of a message generates an audible signal or noise using speaker 122, generates a tactile signal using an oscillator 123, which causes the mobile device to vibrate, and/or generates a visual signal using display 122 or a LED 125 as will be understood by one of ordinary skill in the art.

In some embodiments, ACSN 20 enables commercial user P to provide targeted messages or promotions to checked-in or previously checked in non-commercial users based on demographic data aggregated from social network 60. For example, a commercial user may target non-commercial users based on age, gender, location, ethnicity or the like by contacting an administrator of ACSN 20 that sends the targeted messages or promotions to non-commercial users on behalf of the commercial user. In some embodiments, ACSN 20 may store a count for the number of times a non-commercial user has used the ACSN 20 to check into a particular location such that commercial user P may target frequent visitors with certain promotions and new visitors with different promotions. Such information concerning non-commercial user activity may be stored in computer readable storage medium 26 and associated with an account of the non-commercial user. In some embodiments, the ACSN 20 may provide security/privacy settings that enable non-commercial users to opt out of such targeted marketing.

Not only does ACSN 20 enable a commercial user to transmit messages to currently checked-in non-commercial users as illustrated in FIG. 9, but ACSN 20 also enables messages to be transmitted to previously checked-in non-commercial users that are not currently checked in at the Check-In Location as illustrated in FIG. 10. As shown in FIG. 10, commercial user P is provided with a GUI on display 106 of a mobile device 100 (or a computer 54) for facilitating communication between commercial user P and a plurality of non-commercial users that are presently checked in (e.g., non-commercial users A, B, and C) and a plurality of non-commercial users that had previously checked in (e.g., non-commercial users D and E) at the Check-In Location.

The GUI displayed to commercial user P, which is generated by commercial user portal 30, includes an address area 180 identifying the people to which the message will be transmitted, a text entry box 182 in which the message is to be input, and a virtual “Send Message” button 184. Once the commercial user P enters the message within text entry box 182, the Send Message virtual button 184 is pressed and the message is transmitted to ACSN 20.

ACSN 20 receives the message from mobile device 100 (or remote terminal 54) and transmits the message to each currently checked-in non-commercial user, i.e., non-commercial users A, B, and C, and to previously checked-in non-commercial users, i.e., non-commercial users D and E. The message from ACSN 20 to non-commercial users A, B, C, D, and E can be transmitted using TCP/IP, via an email protocol, SMS protocol, or other suitable communication protocol as will be understood by one of ordinary skill in the art. In some embodiments, the receipt of a message generates an audible signal or noise using speaker 122, generates a tactile signal using an oscillator 123, which causes the mobile device to vibrate, and/or generates a visual signal using display 122 or a LED 125 as will be understood by one of ordinary skill in the art.

As described above, ACSN 20 provides the commercial user with the ability to target subsets of non-commercial users based on demographic data by contacting an administrator of ACSN 20 that facilitates the messaging between commercial users and non-commercial users in some embodiments. Such demographic data can be any data provided by a non-commercial user to a social network social 60. For example, the demographic data can include, but are not limited to, gender, age, race, profession, hair color, eye color, favorite music genre or artist, favorite sports team, income range, state or city of residence, number of children, marriage or relationship status, religious affiliation, and/or favorite movie, to name but only a few possibilities. Accordingly, ACSN 20 provides a commercial user the ability to provide targeting marketing or incentives to non-commercial users. In some embodiments, ACSN 20 requires payment for access to user data or to transmit a targeted message based on non-commercial user data.

Administrators through administrative portal 20 also have the ability to view each of the user (commercial and non-commercial) profiles via back-end GUI 32. In some embodiments as described above, the administrators facilitate the transmission of advertising or promotional materials to the non-commercial users on behalf of commercial users. In some embodiments, ACSN 20 includes a database of promotions, advertisements, or other offers and correlates these promotions, advertisements, or other offers with the profiles of the non-commercial users. Administrators can also provide targeted advertising on behalf of non-users (e.g., advertisers, promoters, or other entities that have not registered with ACSN 20). For example, the administrators can offer to provide advertisers or promoters with targeted marketing to registered users (e.g., commercial and non-commercial users) based on the aggregated data acquired by ACSN 20. As will be understood by one of ordinary skill in the art, a user profile and/or account can identify the gender, age, race, income level, residential address, and favorite food, music, drink, sports team, author, television show, and the like. Such information can be used for targeted marketing promotions facilitated by administrators, which transmit the promotions on behalf of a marketer or promoter to registered users of ACSN 20. As will be understood by one of ordinary skill in the art, ACSN 20 may charge for the services of transmitting the messages on behalf of the non-users (e.g., promoters or marketers).

The disclosed systems and methods can be embodied in the form of methods and apparatus for practicing those methods. In some embodiments, at least a portion of the disclosed systems and methods are be embodied in the form of program code embodied in a tangible media, such as USB flash drives, SD cards, CD-ROMs, DVD-ROMs, Blu-ray disks, hard drives, or any other non-transient machine-readable storage medium, wherein, when the program code is loaded into and executed by a machine, such as a computer, the machine becomes an apparatus for practicing the inventive method. All or parts of the disclosed methods also can be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the method. When implemented on a general-purpose processor, the program code segments combine with the processor to provide a unique device that operates analogously to specific logic circuits.

Although the systems and methods have been described in terms of exemplary embodiments, they are not limited thereto. Rather, the appended claims should be construed broadly, to include other variants and embodiments of the systems and methods, which may be made by those skilled in the art without departing from the scope and range of equivalents of the systems and methods.

What is claimed is:

1. A system, comprising:
a non-transient machine readable storage medium;
a communication interface configured to transmit and receive messages via a network; and
a processor in signal communication with the non-transient machine readable storage medium and the communication interface, the processor configured to:
process location data received from a mobile device with the communication interface, the location data being associated with a user account,
identify a number of check-in locations located within a predetermined distance of the mobile device based on the location data,
generate a first message including the check-in locations located within the predetermined distance of the mobile device,
cause the communication interface to transmit the first message to the mobile device,
process a second message received with the communication interface from the mobile device, the second message including check-in data, and
cause the check-in data to be stored in the non-transient machine readable storage medium such that the check-in data is associated with the user account.

2. The system of claim 1, wherein the check-in data includes a time at which the user account checked in at a check-in location and an identity of the check-in location.

3. The system of claim 1, wherein the processor identifies the number of check-in locations located within the predetermined distance by communicating with a third-party database.

4. The system of claim 1, wherein the processor identifies the number of check-in locations located within the predetermined distance by comparing the location data to a database stored in the non-transient machine readable storage medium.

5. The system of claim 1, wherein the processor is configured to
process a request for check-in data associated with a check-in location, the request associated with an account of a consumer user registered with the check-in location;
generate a third message including the check-in data requested in the request; and
cause the communication interface to transmit the third message such that the check-in data requested in the request is displayed to a user.

6. The system of claim 5, wherein the check-in data requested in the request includes a number of users that have checked in at the check-in location within a period of time.

7. The system of claim 6, wherein the check-in data requested in the request include an identity of the users that have checked in at the check-in location within the period of time.

8. The system of claim 1, wherein the processor is configured to
process a request for a third message to be posted to a shout board, the request received from an account associated with a check-in location; and
update the shout board that is accessible to each registered user to include the third message.

9. The system of claim 1, wherein the processor is configured to
process a third message received from an account associated with a first user, the third message intended for an account associated with a second user
cause the third message to be transmitted to the account associated with the second user by the communication interface, and
wherein the account of the first user is not associated with the account of the second user, and the accounts of the first and second users are contemporaneously active when the third message is processed by the processor and the communication interface transmits the third message to the account of the second user.

10. The system of claim 1, wherein the processor is configured to
receive a request from an account associated with the user to hide the account associated with the user from being visible by accounts associated with other users having email addresses with different top-level domains, and
update the account of the user such that accounts associated with other users cannot view the account associated with the first user if the accounts associated with the other users have different top-level domains.

11. A method, comprising:
processing location data received from a mobile device with the communication interface, the location data being associated with a user account,
identifying a number of check-in locations located within a predetermined distance of the mobile device based on the location data,
generating a first message including the check-in locations located within the predetermined distance of the mobile device,
processing a second message received with the communication device from the mobile device, the second message including check-in data, and
storing the check-in data in a non-transient machine readable storage medium such that the check-in data is associated with the user account.

12. The method of claim 11, wherein the check-in data includes a time at which the user account checked in at a check-in location and an identity of the check-in location.

13. The method of claim 11, wherein identifying the number of check-in locations located within a predetermined distance includes communicating with a third-party database.

14. The method of claim 11, wherein identifying the number of check-in locations located within a predetermined distance includes comparing the location data to a database stored in a non-transient machine readable storage medium.

15. The method of claim 11, further comprising
processing a request for check-in data associated with a check-in location, the request associated with an account of a consumer user registered with the check-in location;
generating a third message including the check-in data requested in the request; and
transmitting the third message such that the check-in data requested in the request is displayed to a user.

16. The method of claim 15, wherein the check-in data requested in the request includes a number of users that have checked in at the check-in location within a period of time.

17. The method of claim 16, wherein the check-in data requested in the request include an identity of the users that have checked in at the check-in location within the period of time.

18. The method of claim 11, further comprising
processing a request for a third message to be posted to a shout board, the request received from an account associated with a check-in location; and
updating the shout board that is accessible to each registered user to include the third message.

19. The method of claim 11, further comprising
processing a third message received from an account associated with a first user, the third message intended for an account associated with a second user
transmitting the third message to the account associated with the second user by the communication interface, and
wherein the account of the first user is not associated with the account of the second user, and the accounts of the first and second users are contemporaneously active when the third message is processed by the processor and the communication interface transmits the third message to the account of the second user.

20. The method of claim 11, further comprising
receiving a request from an account associated with the user to hide the account associated with the user from being visible by accounts associated with other users having email addresses with different top-level domains, and
updating the account of the user such that accounts associated with other users cannot view the account associated with the first user if the accounts associated with the other users have different top-level domains.
